(19) United States
(12) Patent Application Publication
(10) Pub. No.: US 2014/0033098 A1
(43) Pub. Date: Jan. 30, 2014

(54) ELECTRONIC APPARATUS, DISPLAY METHOD AND DISPLAY PROGRAM

(71) Applicant: Toshihiro Uota, Osaka-shi (JP)

(72) Inventor: Toshihiro Uota, Osaka-shi (JP)

(73) Assignee: SHARP KABUSHIKI KAISHA, Osaka-shi, Osaka (JP)

(21) Appl. No.: 14/009,992

(22) PCT Filed: Apr. 5, 2012
(86) PCT No.: PCT/JP2012/059320

§ 371 Date: Oct. 4, 2013

(30) Foreign Application Priority Data
Apr. 7, 2011 (JP) 2011-085468

(51) Int. Cl. G06F 3/0488

(52) U.S. Cl. CPC G06F 3/0488
USPC 715/765

(57) ABSTRACT

An electronic apparatus which allows a user to input various types of operating instructions in simpler operations is provided. An electronic apparatus including a touch panel and a processor for causing the touch panel to display an object including a plurality of types of regions is provided. Based on a touch operation on an object being displayed on the touch panel, the processor causes the object being displayed on the touch panel to be moved in accordance with a rule corresponding to the type of a touched region.

### TECHNICAL FIELD

The present invention relates to an electronic apparatus, a display method and a display program capable of displaying an object on a display, and more particularly to an electronic apparatus, a display method and a display program capable of moving an object in accordance with an operating instruction received through a touch panel.

### BACKGROUND ART

An electronic apparatus which displays an object and receives an operating instruction from a user through a touch panel is known.

For example, Japanese Patent Laying-Open No. 2003-123088 (PTD 1) discloses a graphic drawing method and a graphic measuring method. According to Japanese Patent Laying-Open No. 2003-123088 (PTD 1), in the graphic drawing method for drawing on a screen, a triangle ruler icon displayed on a tool bar is touched by a fingertip or the like, which is detected to display a triangle ruler of a predetermined size stored previously on the central part of the screen. A point except a marked place at a corner of the triangle ruler is dragged by a fingertip or the like. Coordinate data input on that occasion while changing from moment to moment is acquired. The display position of the triangle ruler on the screen is moved in accordance with the coordinate data. Furthermore, the marked place of the triangle ruler is dragged to rotate the triangle ruler being displayed. A touch is given on desired two points on a side of the triangle ruler then displayed to draw a straight line that connects the two points on the screen.

### CITATION LIST

### Patent Document

PTD 1: Japanese Patent Laying-Open No. 2003-123088

### SUMMARY OF INVENTION

### Technical Problem

When changing the position and/or inclination of an object being displayed, however, a user has been required to input an instruction for making a transition to a mode of changing the position, an instruction for making a transition to a mode of changing the inclination and/or the like, in addition to an instruction for adjusting the position and/or inclination of the ruler.

The present disclosure was made to solve such a problem. An object in an aspect is to provide an electronic apparatus that allows a user to input various types of operating instructions in simpler operations.

An object in another aspect is to provide a display method that allows a user to input various types of operating instructions in simpler operations.

An object in still another aspect is to provide a display program that allows a user to input various types of operating instructions in simpler operations.

### Solution to Problem

According to an embodiment, an electronic apparatus including a touch panel and a processor for causing the touch panel to display an object including a plurality of types of regions is provided. The processor is configured to, based on a touch operation on the object being displayed on the touch panel, cause the object being displayed on the touch panel to be moved in accordance with a rule corresponding to the type of a region touched.

Preferably, the object has at least one side as the region. The processor is configured to cause the object to be translated along the side based on the touch operation on the side.

Preferably, the object has at least one arc as the region. The processor is configured to cause the object to be rotated centering on the center of the arc based on the touch operation on the arc.

Preferably, the object has at least one vertex as the region. The processor is configured to cause the object to be rotated based on the touch operation on the vertex.

Preferably, the processor is configured to cause the object to be rotated centering on the center of gravity of the object based on the touch operation on the vertex.

Preferably, the object has an opposite side of the vertex. The processor is configured to cause the object to be rotated centering on the center of the opposite side based on the touch operation on the vertex.

Preferably, the object has a plurality of vertices as the region. The processor is configured to, based on the touch operation on one of the plurality of vertices, cause the object to be rotated centering on any vertex adjacent to the one of the plurality of vertices.

Preferably, the processor is configured to cause the object to be translated based on the touch operation on the inside of the object.

According to another embodiment, a display method in an electronic apparatus including a touch panel and a processor is provided. The display method includes the steps of causing, by the processor, the touch panel to display an object including a plurality of types of regions, receiving, by the processor, a touch operation on the object being displayed on the touch panel, and based on the touch operation, causing, by the processor, the object being displayed on the touch panel to be moved in accordance with a rule corresponding to the type of a region touched.

According to still another embodiment, a display program for causing an electronic apparatus including a touch panel and a processor to display an object is provided. The display program causes the processor to execute the steps of causing the touch panel to display an object including a plurality of types of regions, receiving a touch operation on the object being displayed on the touch panel, and based on the touch operation, causing the object being displayed on the touch panel to be moved in accordance with a rule corresponding to the type of a region touched.

In an aspect, a user can input various types of operating instructions in simpler operations.

The foregoing and other objects, features, aspects, and advantages of the present invention will become more apparent from the following detailed description of the present invention when taken in conjunction with the accompanying drawings.

### BRIEF DESCRIPTION OF DRAWINGS

FIG. 1 is a first schematic diagram showing an outline of operation of a straight ruler mode of an electronic apparatus 100 according to the present embodiment.

FIG. 2 is a second schematic diagram showing an outline of operation of the straight ruler mode of electronic apparatus 100 according to the present embodiment.

FIG. 3 is a first schematic diagram showing an outline of operation of a triangle ruler mode of electronic apparatus 100 according to the present embodiment.

FIG. 4 is a second schematic diagram showing an outline of operation of the triangle ruler mode of electronic apparatus 100 according to the present embodiment.

FIG. 5 is a first schematic diagram showing an outline of operation of a protractor mode of electronic apparatus 100 according to the present embodiment.

FIG. 6 is a second schematic diagram showing an outline of operation of the protractor mode of electronic apparatus 100 according to the present embodiment.

FIG. 7 is a schematic diagram showing an outline of operation of an image mode of electronic apparatus 100 according to the present embodiment.

FIG. 8 is a block diagram showing a hardware configuration of electronic apparatus 100 according to the present embodiment.

FIG. 9A is a flowchart showing a procedure of display processing in electronic apparatus 100 according to the present embodiment.

FIG. 9B is a flowchart showing a procedure of display processing in electronic apparatus 100 according to the present embodiment.

FIG. 10A is a schematic diagram showing a method for determining which region of an object has been touched according to the present embodiment.

FIG. 10B is a schematic diagram showing a method for determining which region of an object has been touched according to the present embodiment.

FIG. 10C is a schematic diagram showing a method for determining which region of an object has been touched according to the present embodiment.

FIG. 11 is a schematic diagram showing a method for translating an object based on a drag operation on a side according to the present embodiment.

FIG. 12 is a first schematic diagram showing a method for rotating an object based on a drag operation on a vertex according to the present embodiment.

FIG. 13 is a second schematic diagram showing a method for rotating an object based on a drag operation on a vertex according to the present embodiment.

FIG. 14 is a third schematic diagram showing a method for rotating an object based on a drag operation on a vertex according to the present embodiment.

FIG. 15 is a first schematic diagram showing a method for rotating an object based on a drag operation on a circular arc according to the present embodiment.

FIG. 16 is a schematic diagram showing a method for translating an object based on a drag operation according to the present embodiment.

### DESCRIPTION OF EMBODIMENTS

Hereinafter, an embodiment of the present invention will be described with reference to the drawings. In the drawings, the same or corresponding portions have the same reference characters allotted. They also have the same names and functions. Therefore, detailed description thereof will not be repeated.

<Overall Configuration of Electronic Apparatus 100>

First, the overall configuration of electronic apparatus 100 according to the present embodiment will be described. Electronic apparatus 100 is implemented by a device having a touch panel, such as an electronic note, a personal computer, a mobile phone, an electronic dictionary, and a PDA (Personal Digital Assistant).

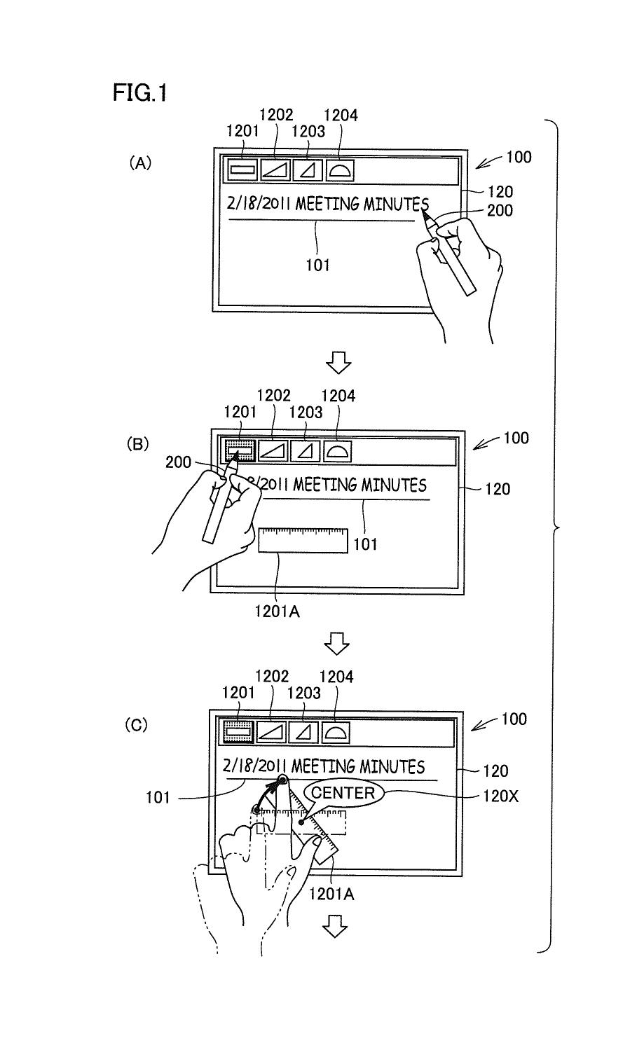

FIG. 1 is a first schematic diagram showing an outline of operation of a straight ruler mode of electronic apparatus 100 according to the present embodiment. More specifically, a screen A of FIG. 1 shows a schematic diagram of electronic apparatus 100 in a state where a user has input characters by handwriting on a touch panel 120 using a stylus pen 200. A screen B of FIG. 1 shows a schematic diagram of electronic apparatus 100 in a state where the user has touched a straight ruler button 1201 using stylus pen 200. A screen C of FIG. 1 shows a schematic diagram of electronic apparatus 100 in a state where the user has dragged a vertex of a straight ruler 1201A.

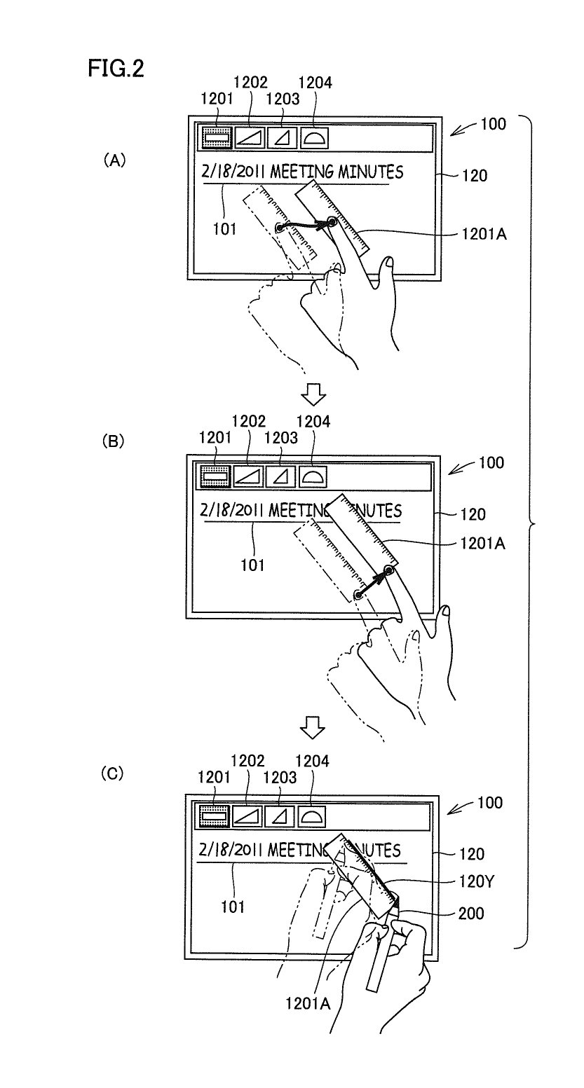

FIG. 2 is a second schematic diagram showing an outline of operation of the straight ruler mode of electronic apparatus 100 according to the present embodiment. Screen A of FIG. 2 shows a schematic diagram of electronic apparatus 100 in a state where the user has dragged the inside of straight ruler 1201A. Screen B of FIG. 2 shows a schematic diagram of electronic apparatus 100 in a state where the user has dragged a side of straight ruler 1201A. Screen C of FIG. 2 shows a schematic diagram of electronic apparatus 100 in a state where the user has slid stylus pen 200 in proximity to a side of straight ruler 1201A.

Referring to FIGS. 1 and 2, electronic apparatus 100 includes touch panel 120 on which coordinates of a touch by a finger or stylus pen 200 can be acquired. In the present embodiment, touch panel 120 includes a tablet detecting the coordinates of a touch by a user, and a liquid crystal display. Touch panel 120 receives a touch operation on touch panel 120, and receives various instructions from the user based on touch coordinates or the locus of touch coordinates. Touch panel 120 displays a handwritten image (including a handwritten character), a predetermined character, a predetermined image, and the like based on various instructions from the user. It is noted that, while electronic apparatus 100 according to the present embodiment receives an instruction from the user through touch panel 120, electronic apparatus 100 may have a hardware keyboard and other switches besides touch panel 120.

In the present embodiment, touch panel 120 displays straight ruler button 1201 for making a transition to the straight ruler mode, a first triangle ruler button 1202 for making a transition to a first triangle ruler mode, a second triangle ruler button 1203 for making a transition to a second triangle ruler mode, and a protractor button 1204 for making a transition to a protractor mode in a selectable manner.

<Outline of Operation of Electronic Apparatus 100>

The following will describe an outline of operation of electronic apparatus 100 according to the present embodiment for each mode (straight ruler mode, triangle ruler mode, protractor mode).

(Straight Ruler Mode)

Referring to screen A of FIG. 1, electronic apparatus 100 receives a handwriting instruction from the user through touch panel 120. On touch panel 120, a straight line or a curve corresponding to the locus of touch coordinates of stylus pen 200 on touch panel 120 is drawn. For example, the user can write handwritten characters 101 on touch panel 120 using stylus pen 200.

Referring to screen B of FIG. 1, electronic apparatus 100 receives a transition instruction to the straight ruler mode from the user through touch panel 120. More specifically, electronic apparatus 100 detects that the user has pressed down straight ruler button 1201 through touch panel 120, thereby making a transition to the straight ruler mode. Electronic apparatus 100 causes touch panel 120 to display straight ruler 1201A.

Referring to screen C of FIG. 1, the user touches a vertex of straight ruler 1201A, and drags that vertex. Then, electronic apparatus 100 causes straight ruler 1201A to be rotated with the center of gravity of straight ruler 1201A serving as center 120X in accordance with the drag operation.

Referring to screen A of FIG. 2, the user touches the inside of straight ruler 1201A, and drags straight ruler 1201A. Then, electronic apparatus 100 causes straight ruler 1201A to be translated in accordance with the drag operation.

Referring to screen B of FIG. 2, the user touches a side of straight ruler 1201A, and drags that side. Then, electronic apparatus 100 causes straight ruler 1201A to be translated along the side in accordance with the drag operation.

Referring to screen C of FIG. 2, when the user slides stylus pen 200 on touch panel 120 along the side of straight ruler 1201A, electronic apparatus 100 causes a straight line 120Y along the side of straight ruler 1201A being displayed to be displayed based on the locus of stylus pen 200.

(Triangle Ruler Mode)

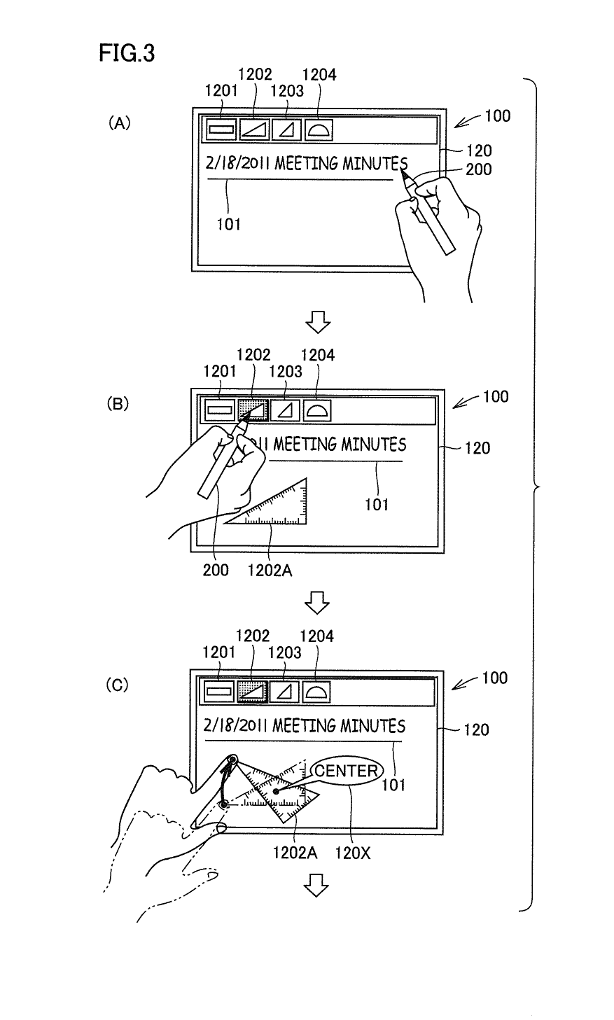

FIG. 3 is a first schematic diagram showing an outline of operation of the triangle ruler mode of electronic apparatus 100 according to the present embodiment. More specifically, screen A of FIG. 3 shows a schematic diagram of electronic apparatus 100 in a state where the user has input handwritten characters 101 on touch panel 120 using stylus pen 200. Screen B of FIG. 3 shows a schematic diagram of electronic apparatus 100 in a state where the user has touched first triangle ruler button 1202 using stylus pen 200. Screen C of FIG. 3 shows a schematic diagram of electronic apparatus 100 in a state where the user has dragged a vertex of a triangle ruler 1202A.

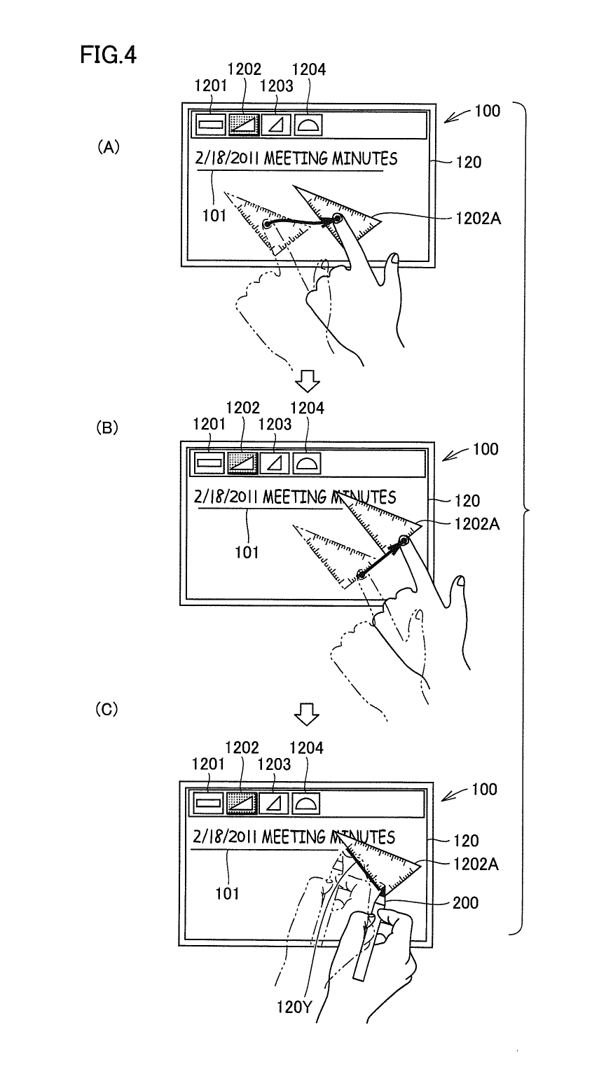

FIG. 4 is a second schematic diagram showing an outline of operation of the triangle ruler mode of electronic apparatus 100 according to the present embodiment. More specifically, screen A of FIG. 4 shows a schematic diagram of electronic apparatus 100 in a state where the user has dragged the inside of triangle ruler 1202A. Screen B of FIG. 4 shows a schematic diagram of electronic apparatus 100 in a state where the user has dragged a side of triangle ruler 1202A. Screen C of FIG. 4 shows a schematic diagram of electronic apparatus 100 in a state where the user has slid stylus pen 200 in proximity to a side of triangle ruler 1202A displayed.

Referring to screen A of FIG. 3, electronic apparatus 100 receives a handwriting instruction from the user through touch panel 120. On touch panel 120, a straight line or a curve corresponding to the locus of touch coordinates of stylus pen 200 on touch panel 120 is drawn. For example, the user can write handwritten characters 101 on touch panel 120 using stylus pen 200.

Referring to screen B of FIG. 3, electronic apparatus 100 receives a transition instruction to the triangle ruler mode from the user through touch panel 120. More specifically, electronic apparatus 100 detects that the user has pressed down first triangle ruler button 1202 through touch panel 120, thereby making a transition to the triangle ruler mode. Electronic apparatus 100 causes touch panel 120 to display triangle ruler 1202A.

Referring to screen C of FIG. 3, the user touches a vertex of triangle ruler 1202A, and drags that vertex. Then, electronic apparatus 100 causes triangle ruler 1202A to be rotated centering on the center of gravity of triangle ruler 1202A in accordance with the drag operation.

Referring to screen A of FIG. 4, the user touches the inside of triangle ruler 1202A, and drags triangle ruler 1202A. Then, electronic apparatus 100 causes triangle ruler 1202A to be translated in accordance with the drag operation.

Referring to screen B of FIG. 4, the user touches a side of triangle ruler 1202A, and drags that side. Then, electronic apparatus 100 causes triangle ruler 1202A to be translated along the side in accordance with the drag operation.

Referring to screen C of FIG. 4, when the user slides stylus pen 200 on touch panel 120 along the side of triangle ruler 1202A, electronic apparatus 100 causes straight line 120Y along the side of triangle ruler 1202A being displayed to be displayed based on the locus of stylus pen 200.

(Protractor Mode)

FIG. 5 is a first schematic diagram showing an outline of operation of the protractor mode of electronic apparatus 100 according to the present embodiment. More specifically, screen A of FIG. 5 shows a schematic diagram of electronic apparatus 100 in a state where the user has input handwritten characters 101 on touch panel 120 using stylus pen 200. Screen B of FIG. 5 shows a schematic diagram of electronic apparatus 100 in a state where the user has touched protractor button 1204 using stylus pen 200. Screen C of FIG. 5 shows a schematic diagram of electronic apparatus 100 in a state where the user has dragged a vertex of a protractor 1204A.

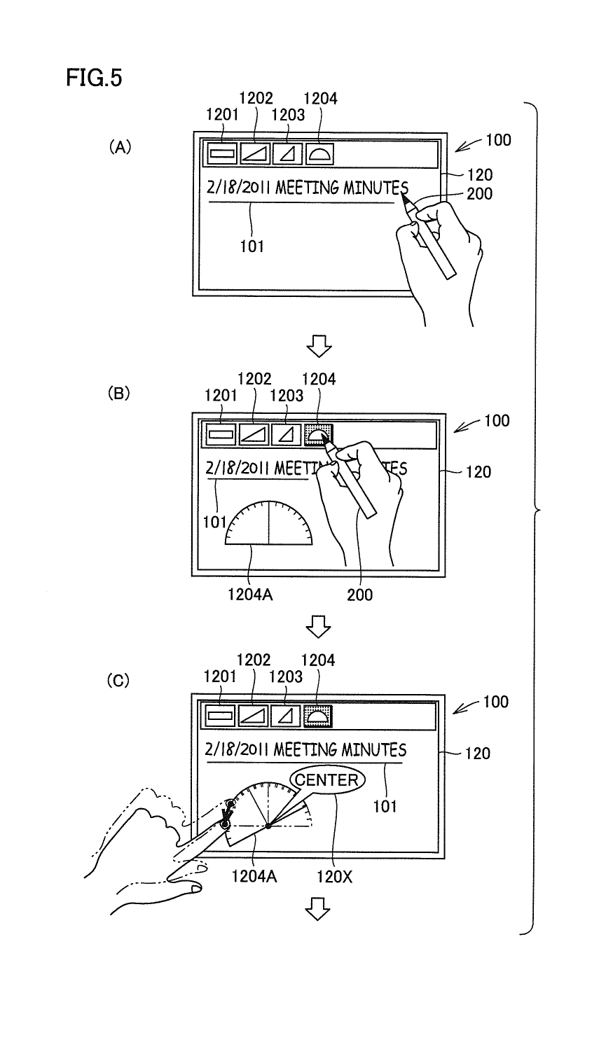

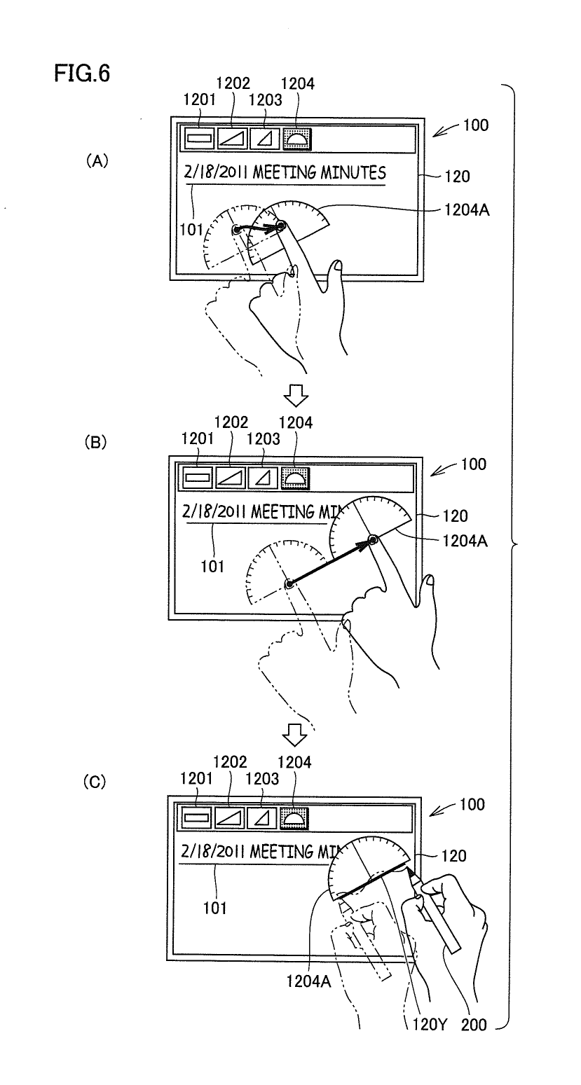

FIG. 6 is a second schematic diagram showing an outline of operation of the protractor mode of electronic apparatus 100 according to the present embodiment. More specifically, screen A of FIG. 6 shows a schematic diagram of electronic apparatus 100 in a state where the user has dragged the inside of protractor 1204A. Screen B of FIG. 6 shows a schematic diagram of electronic apparatus 100 in a state where the user has dragged a side of protractor 1204A. Screen C of FIG. 6 shows a schematic diagram of electronic apparatus 100 in a state where the user has slid stylus pen 200 in proximity to a side of protractor 1204A displayed.

Referring to screen A of FIG. 5, electronic apparatus 100 receives a handwriting instruction from the user through touch panel 120. On touch panel 120, a straight line or a curve corresponding to the locus of touch coordinates of stylus pen 200 on touch panel 120 is drawn. For example, the user can write handwritten characters 101 on touch panel 120 using stylus pen 200.

Referring to screen B of FIG. 5, electronic apparatus 100 receives a transition instruction to the protractor mode from the user through touch panel 120. More specifically, electronic apparatus 100 detects that the user has pressed down protractor button 1204 through touch panel 120, thereby making a transition to the protractor mode. Electronic apparatus 100 causes touch panel 120 to display protractor 1204A.

Referring to screen C of FIG. 5, the user touches a circular arc of protractor 1204A, and drags that circular arc. Then, electronic apparatus 100 causes protractor 1204A to be rotated centering on the center of the side of protractor 1204A in accordance with the drag operation. It is noted that the user touches a vertex of protractor 1204A, and drags that vertex. Then, electronic apparatus 100 may cause protractor 1204A to be rotated centering on the center of gravity of protractor 1204A in accordance with the drag operation.

Referring to screen A of FIG. 6, the user touches the inside of protractor 1204A, and drags protractor 1204A. Then, electronic apparatus 100 causes protractor 1204A to be translated in accordance with the drag operation.

Referring to screen B of FIG. 6, the user touches the side of protractor 1204A, and drags that side. Then, electronic apparatus 100 causes protractor 1204A to be translated along the side in accordance with the drag operation.

Referring to screen C of FIG. 6, when the user slides stylus pen 200 on touch panel 120 along the side of protractor 1204A, electronic apparatus 100 causes straight line 120Y along the side of protractor 1204A being displayed to be displayed based on the locus of stylus pen 200.

(Another Image Mode)

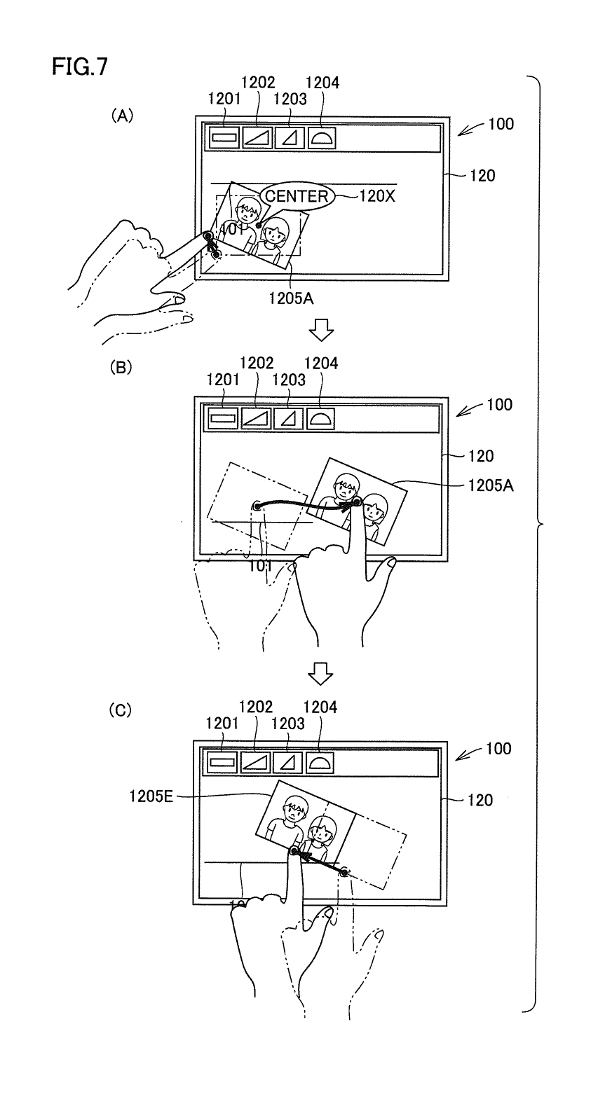

FIG. 7 is a schematic diagram showing an outline of operation of an image mode of electronic apparatus 100 according to the present embodiment. More specifically, screen A of FIG. 7 shows a schematic diagram of electronic apparatus 100 in a state where the user has dragged a vertex of an image 1205A. Screen B of FIG. 7 shows a schematic diagram of electronic apparatus 100 in a state where the user has dragged the inside of image 1205A. Screen C of FIG. 7 shows a schematic diagram of electronic apparatus 100 in a state where the user has dragged a side of image 1205A.

Referring to screen A of FIG. 7, the user touches a vertex of image 1205A, and drags that vertex. Then, electronic apparatus 100 causes image 1205A to be rotated with the center of gravity of image 1205A serving as center 120X in accordance with the drag operation.

Referring to screen B of FIG. 7, the user touches the inside of image 1205A, and drags image 1205A. Then, electronic apparatus 100 causes image 1205A to be translated in accordance with the drag operation.

Referring to screen C of FIG. 7, the user touches a side of image 1205A, and drags that side. Then, electronic apparatus 100 causes image 1205A to be translated along the side in accordance with the drag operation.

It is noted that electronic apparatus 100 may cause a hold button not shown to be displayed in the mode of moving/rotating an object. While the hold button is pressed down, electronic apparatus 100 holds the position and inclination of straight ruler 1201A, and receives input of a handwritten image by stylus pen 200.

Alternatively, electronic apparatus 100 may cause a hold button not shown to be displayed in the mode of moving/rotating an object. In accordance with a depression of the hold button, electronic apparatus 100 makes a transition from the mode of moving/rotating an object to the mode of receiving input of a handwritten image. On the contrary, in the mode of receiving input of a handwritten image, electronic apparatus 100 causes a move button not shown to be displayed. In accordance with a depression of the move button, electronic apparatus 100 makes a transition from the mode of receiving input of a handwritten image to the mode of moving/rotating an object.

Alternatively, electronic apparatus 100 can switch between the mode of moving/rotating an object and the mode of receiving input of a handwritten image each time a selection button for an object, such as straight ruler button 1201, is touched.

Alternatively, electronic apparatus 100 can cause an object to be moved and rotated based on a drag operation when a touch area is large (i.e., when a finger is in contact) and receive input of a handwritten image based on a drag operation when the touch area is small (i.e., when the leading end of stylus pen 200 is in contact).

In this way, electronic apparatus 100 according to the present embodiment can cause an object to be redisplayed at a desired position and a desired inclination in simple touch operation. A specific configuration of electronic apparatus 100 for achieving such functions will be described below in detail.

<Hardware Configuration of Electronic Apparatus 100>

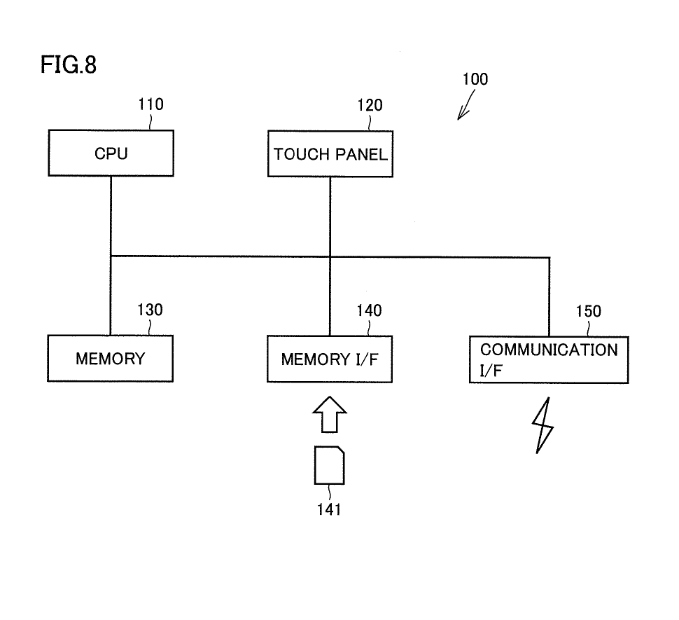

Next, referring to FIG. 8, a mode of the specific configuration of electronic apparatus 100 will be described. FIG. 8 is a block diagram showing a hardware configuration of electronic apparatus 100 according to the present embodiment. As shown in FIG. 8, electronic apparatus 100 includes a CPU 110, touch panel 120, a memory 130, a memory interface 140, and a communication interface 150, as main components.

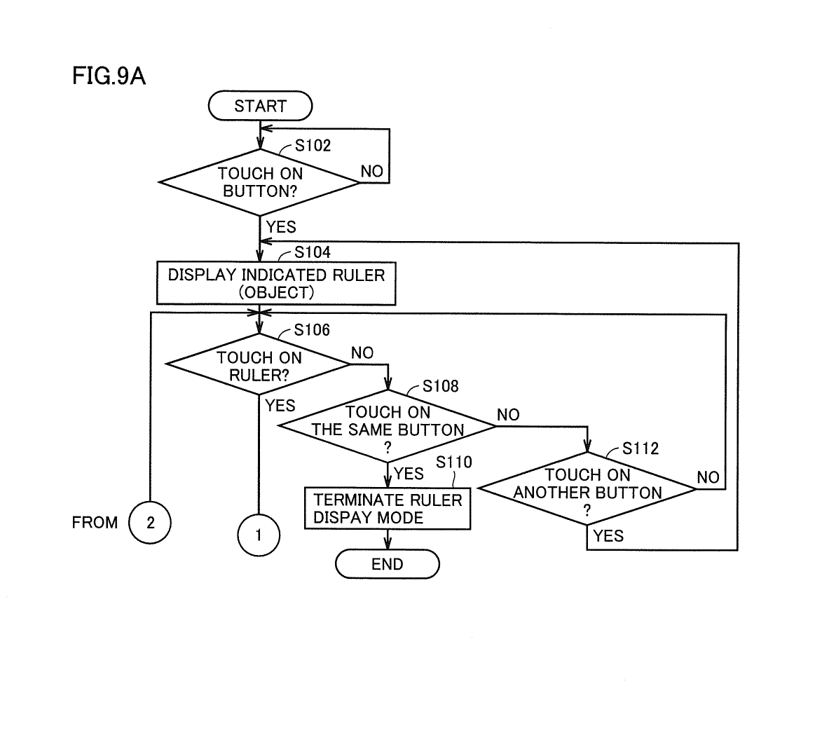

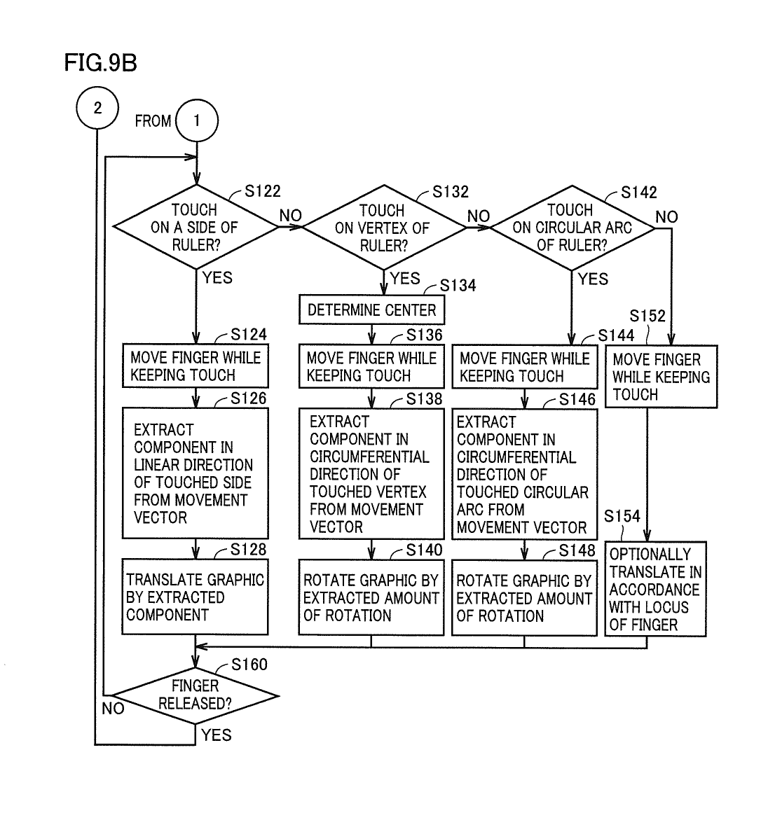

CPU 110 executes a program stored in memory 130 or an external storage medium 141, thereby controlling each unit of electronic apparatus 100. CPU 110 executes a program stored in memory 130 or external storage medium 141, thereby achieving the movements shown in FIGS. 1 to 7, processing shown in FIGS. 9A and 9B, and the like.

Touch panel 120 may be of any type, such as a resistive film type, a surface acoustic wave type, an infrared type, an electromagnetic induction type, or a capacitance type. Touch panel 120 may include an optical sensor liquid crystal. Touch panel 120 detects a touch operation on touch panel 120 by an external subject at predetermined time intervals, and inputs touch coordinates (coordinates) to CPU 110. Touch panel 120 can detect a plurality of touch coordinates.

CPU 110 can also receive a sliding operation (the locus of touch coordinates) based on touch coordinates received sequentially from touch panel 120. Touch panel 120 displays a handwritten image, a predetermined character, or a predetermined image based on data from CPU 110.

Memory 130 is implemented by various types of RAMs (Random Access Memory), ROM (Read-Only Memory), a hard disk, or the like. Alternatively, memory 130 is also implemented by a medium storing a program in a nonvolatile manner utilized through an interface for reading, such as a USB (Universal Serial Bus) memory, a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, a magnetic tape, a cassette tape, an MO (Magnetic Optical Disc), an MD (Mini Disc), an IC (Integrated Circuit) card (except for a memory card), an optical card, a mask ROM, an EPROM, and an EEPROM (Electronically Erasable Programmable Read-Only Memory).

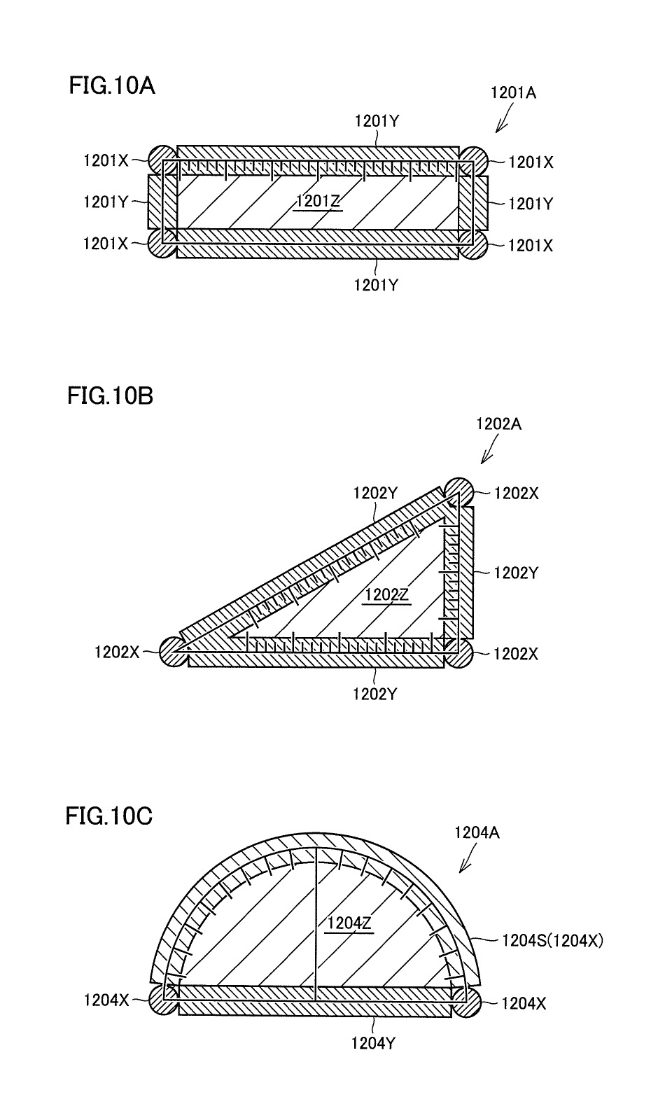

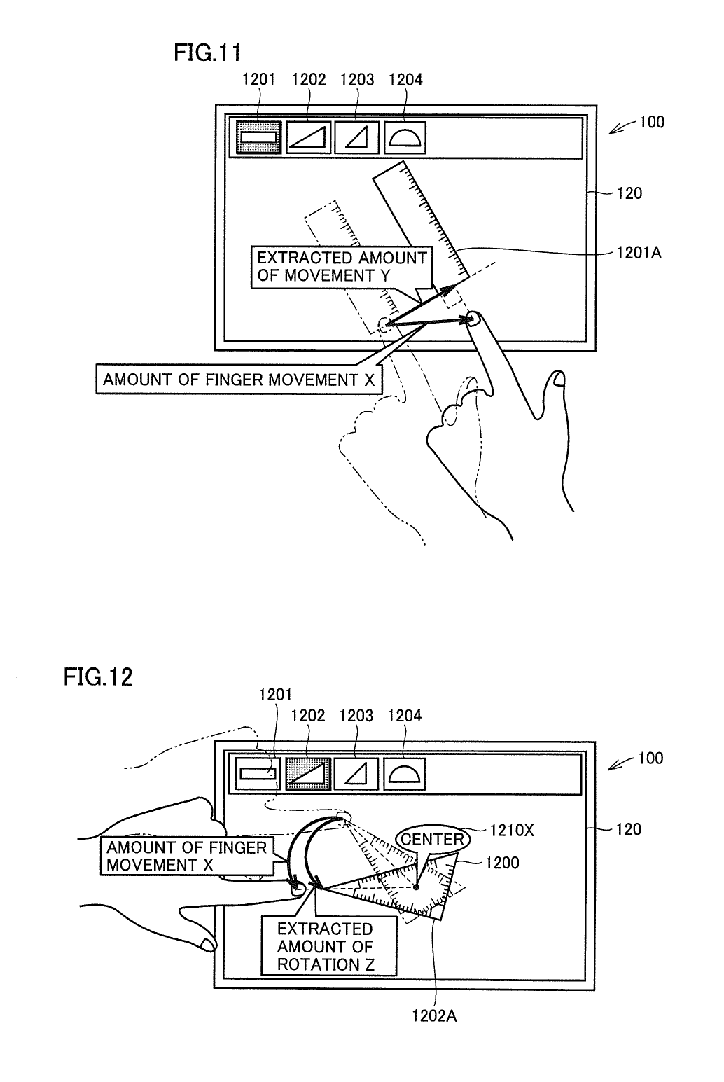

Memory 130 stores a program to be executed by CPU 110, data generated by execution of the program by CPU 110, data received through touch panel 120, and the like. In particular, memory 130 according to the present embodiment stores information as shown in FIG. 10 indicating, for each object, an area of a side and in proximity to the side, an area of a vertex and in proximity to the vertex, an area of an arc and in proximity to the arc, and an area inside an object. Memory 130 also stores, for each area, the correspondence relation between a touch operation and a rule for moving an object (information indicating how to translate an object, information indicating how to rotate an object or the like), as shown in FIGS. 11 to 16.

CPU 110 reads data stored in external storage medium 141 through memory interface 140, and stores the data in memory 130. On the contrary, CPU 110 reads data from memory 130, and stores the data in external storage medium 141 through memory interface 140.

It is noted that examples of storage medium 141 include a medium storing a program in a nonvolatile manner, such as a CD-ROM, a DVD-ROM, a USB memory, a memory card, an FD, a hard disk, a magnetic tape, a cassette tape, an MO, an MD, an IC card (except for a memory card), an optical card, a mask ROM, an EPROM, and an EEPROM.

Communication interface 150 is implemented by an antenna and a connector. Communication interface 150 exchanges data with another device by wire communications or wireless communications. Through communication interface 150, CPU 110 receives a program, image data, text data, and the like from another device, and transmits image data and text data to another device.

<Display Processing>

Next, referring to FIGS. 9A and 9B, display processing in electronic apparatus 100 according to the present embodiment will be described. FIGS. 9A and 9B are flowcharts each showing the procedure of display processing in electronic apparatus 100 according to the present embodiment.

As shown in FIG. 9A, CPU 110 determines whether or not any of straight ruler button 1201, first triangle ruler button 1202, second triangle ruler button 1203, and protractor button 1204 has been selected through touch panel 120 (step S102). When none of the buttons has been selected (NO in step S102), CPU 110 repeats the processing of step S102.

When a button has been selected (YES in step S102), CPU 110 causes touch panel 120 to display a ruler (object) corresponding to the selected button (step S104). It should be noted that CPU 110 may receive an instruction to select an image, such as a photo or an animation, and may cause touch panel 120 to display that image as an object.

CPU 110 determines whether or not the user has touched the ruler through touch panel 120 (step S106). When the user has not touched the ruler (NO in step S106), CPU 110 determines whether or not the same button as before has been selected through touch panel 120 (step S108).

When the same button as before has been selected (YES in step S108), CPU 110 causes touch panel 120 to terminate the display of the object (step S110). CPU 110 terminates the process.

When the same button as before has been selected (NO in step S108), CPU 110 determines whether or not any other button has been selected through touch panel 120 (step S112). When no other button has been selected (NO in step S112), the processing is repeated from step S106. When any other button has been selected (YES in step S112), the processing is repeated from step S104.

When the user has touched the object (YES in step S106), CPU 110 switches control to step S122.

Referring to FIG. 9B, CPU 110 determines whether or not the user has touched a side of the object through touch panel 120 (step S122).

A method for CPU 110 to determine which region of an object has been touched will be described below.

FIGS. 10A to 10C are schematic diagrams each showing a method for determining which region of an object has been touched according to the present embodiment. More specifically, FIG. 10A is a schematic diagram showing a method for determining which region of straight ruler 1201A has been touched. FIG. 10B is a schematic diagram showing a method for determining which region of triangle ruler 1202A has been touched. FIG. 10C is a schematic diagram showing a method for determining which region of protractor 1204A has been touched.

Referring to FIG. 10A, in the case where straight ruler 1201A is displayed, when detecting touch coordinates in an area 1201X of a vertex of straight ruler 1201A and in proximity to the vertex, CPU 110 determines that the user has touched the vertex of straight ruler 1201A. When detecting touch coordinates in an area 1201Y of a side of straight ruler 1201A and in proximity to the side, CPU 110 determines that the user has touched the side of straight ruler 1201A. When detecting touch coordinates in an area 1201Z inside straight ruler 1201A, CPU 110 determines that the user has touched the inside of straight ruler 1201A.

Referring to FIG. 10B, in the case where triangle ruler 1202A is displayed, when detecting touch coordinates in an area 1202X of a vertex of triangle ruler 1202A and in proximity to the vertex, CPU 110 determines that the user has touched the vertex of triangle ruler 1202A. When detecting touch coordinates in an area 1202Y of a side of triangle ruler 1202A and in proximity to the side, CPU 110 determines that the user has touched the side of triangle ruler 1202A. When detecting touch coordinates in an area 1202Z inside triangle ruler 1202A, CPU 110 determines that the user has touched the inside of straight ruler 1201A.

Referring to FIG. 10C, in the case where protractor 1204A is displayed, when detecting touch coordinates in an area 1204X of a vertex of protractor 1204A and in proximity to the vertex, CPU 110 determines that the user has touched the vertex of protractor 1204A. When detecting touch coordinates in an area 1204Y of a side of protractor 1204A and in proximity to the side, CPU 110 determines that the user has touched the side of protractor 1204A. When detecting touch coordinates in an area 1204Z inside protractor 1204A, CPU 110 determines that the user has touched the inside of protractor 1204A. When detecting touch coordinates in an area 1204S of a circular arc of protractor 1204A and in proximity to the circular arc, CPU 110 determines that the user has touched the circular arc of protractor 1204A.

Returning to FIG. 9B, when the user has touched the side of the object (YES in step S122), CPU 110 causes the object to be translated based on the detected drag operation. A method for CPU 110 to cause the object to be translated based on a drag operation on a side will be described.

FIG. 11 is a schematic diagram showing a method for translating an object based on a drag operation on a side according to the present embodiment. Referring to FIG. 9B and FIG. 11, CPU 110 acquires the locus of touch coordinates on a side of an object through touch panel 120 (step S124). CPU 110 extracts a component parallel to the touched side (extracted amount of movement Y) from a finger movement vector (amount of finger movement X) (step S126). CPU 110 causes touch panel 120 to translate the object by the parallel component (step S128).

Returning to FIG. 9B, CPU 110 determines whether or not the user's finger has been released from touch panel 120, through touch panel 120 (step S160). When the user's finger is touching touch panel 120 (NO in step S160), CPU 110 repeats the process from step S122. When the user's finger has been released from touch panel 120 (YES in step S160), CPU 110 repeats the process from step S106.

When the user has not touched the side of the object (NO in step S122), CPU 110 determines whether or not the user has touched a vertex of the object (step S132). When the user has touched the vertex of the object (YES in step S132), CPU 110 causes the object to be rotated based on the detected drag operation. A method for CPU 110 to cause an object to be rotated based on a drag operation on a vertex will be described below.

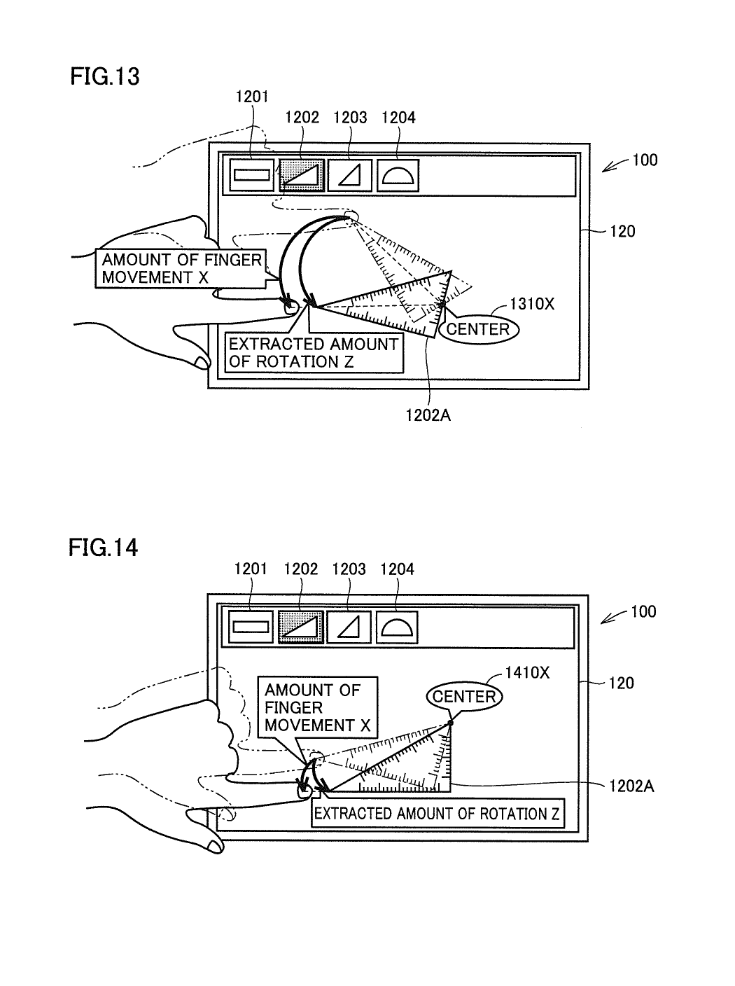

FIG. 12 is a first schematic diagram showing a method for rotating an object based on a drag operation on a vertex according to the present embodiment. FIG. 13 is a second schematic diagram showing a method for rotating an object based on a drag operation on a vertex according to the present embodiment. FIG. 14 is a third schematic diagram showing a method for rotating an object based on a drag operation on a vertex according to the present embodiment.

Referring to FIGS. 9B and 12, CPU 110 calculates coordinates of the center of gravity of an object being displayed, as center 1210X of rotation of triangle ruler 1202A as an object 1200 (step S134). CPU 110 acquires the locus of touch coordinates on a vertex of the object, through touch panel 120 (step S136). CPU 110 extracts a component in the circumferential direction of a circle centering on the center of gravity (extracted amount of movement Z), from a finger movement vector (amount of finger movement X) (step S138). CPU 110 causes touch panel 120 to rotate the object by the component in the circumferential direction (step S140). At this time, CPU 110 may cause an image to be displayed which indicates the center of rotation on touch panel 120. CPU 110 repeats the process from step S160.

Alternatively, referring to FIGS. 9B and 13, CPU 110 calculates coordinate values of the center of the opposite side of the touched vertex, as center 1310X of rotation of triangle ruler 1202A as object 1200 (step S134). CPU 110 acquires the locus of touch coordinates on the vertex of the object, through touch panel 120 (step S136). CPU 110 extracts a component in the circumferential direction of a circle centering on the center of the opposite side of the touched vertex (extracted amount of movement Z), from a finger movement vector (amount of finger movement X) (step S138). CPU 110 causes touch panel 120 to rotate the object by the component in the circumferential direction (step S140). At this time, CPU 110 may cause an image to be displayed which indicates the center of rotation on touch panel 120. CPU 110 repeats the process from step S160.

Alternatively, referring to FIGS. 9B and 14, CPU 110 calculates coordinates of a vertex adjacent clockwise to the touched vertex, as center 1410X of rotation of triangle ruler 1202A as object 1200 (step S134). CPU 110 acquires the locus of touch coordinates on the vertex of the object, through touch panel 120 (step S136). CPU 110 extracts a component in the circumferential direction of a circle centering on the vertex adjacent clockwise to the touched vertex (extracted amount of movement Z), from a finger movement vector (amount of finger movement X) (step S138). CPU 110 causes touch panel 120 to rotate the object by the component in the circumferential direction (step S140). At this time, CPU 110 may cause an image to be displayed which indicates the center of rotation on touch panel 120. CPU 110 repeats the process from step S160.

Returning to FIG. 9B, when the user has not touched the vertex of the object (NO in step S132), CPU 110 determines whether or not the user has touched a circular arc of the object (step S142). When the user has touched the circular arc of the object (YES in step S142), CPU 110 causes the object to be rotated based on the detected drag operation. A method for CPU 110 to cause the object to be rotated based on a drag operation on a circular arc will be described below.

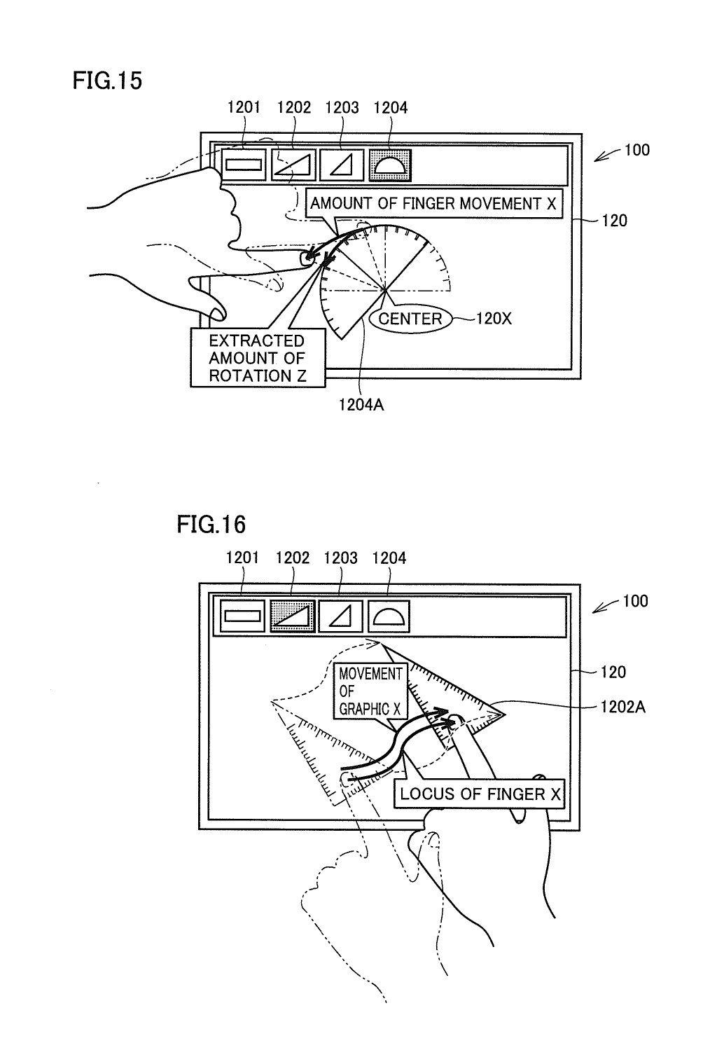

FIG. 15 is a first schematic diagram showing a method for causing an object to be rotated based on a drag operation on a circular arc according to the present embodiment. Referring to FIGS. 9B and 15, CPU 110 acquires the locus of touch coordinates of a finger, through touch panel 120 (step S144). CPU 110 extracts a component in the direction of the circular arc (extracted amount of movement Z), from a finger movement vector (amount of finger movement X) (step S146). CPU 110 causes touch panel 120 to rotate the object by the component in the direction of the circular arc (step S148). CPU 110 repeats the process from step S160.

Returning to FIG. 9B, when the user has not touched the circular arc of the object (NO in step S142), CPU 110 causes the object to be translated based on the detected drag operation. A method for CPU 110 to cause an object to be translated based on a drag operation on a side will be described below.

FIG. 16 is a schematic diagram showing a method for causing an object to be translated based on a drag operation according to the present embodiment. Referring to FIGS. 9B and 16, CPU 110 acquires the locus of touch coordinates of a finger through touch panel 120 (step S152). CPU 110 causes touch panel 120 to translate the object based on a finger movement vector (amount of finger movement X) (step S154). CPU 110 repeats the process from step S160.

### OTHER APPLICATIONS

It is needless to say that the technical idea according to the present embodiment is also applicable to the case implemented by providing a system or a device with a program. The effects of the present invention can also be enjoyed by providing a system or a device with external storage medium 141 (memory 130) storing a program represented by software for achieving the present invention and by a computer (or CPU or MPU) of the system or the device reading and executing a program code stored in external storage medium 141 (memory 130).

In this case, the program code itself read from external storage medium 141 (memory 130) will achieve the functions of the above-described embodiment, and external storage medium 141 (memory 130) storing that program code will implement the present invention.

Moreover, it is needless to say that the invention also covers the case in which not only the functions of the above-described embodiment are achieved by the computer executing the read program code, but also the OS (operating system) working on the computer or the like performs actual processing partially or entirely based on instructions in that program code, so that the functions of the above-described embodiment are achieved by that processing.

Furthermore, it is needless to say that the invention also covers the case in which, after the program code read from external storage medium 141 (memory 130) is written into another storage medium provided for a function expansion board inserted in the computer or a function expansion unit connected to the computer, CPU or the like provided for the function expansion board or the function expansion unit performs actual processing partially or entirely based on instructions in that program code, so that the functions of the above-described embodiment are achieved by that processing.

Although the present invention has been described and illustrated in detail, it is clearly understood that the same is by way of illustration and example only and is not to be taken by way of limitation, the scope of the present invention being interpreted by the appended claims.

### REFERENCE SIGNS LIST

100 electronic apparatus, 110 CPU, 120 touch panel, 1201 straight ruler button, 1201A straight ruler, 1202 first triangle ruler button, 1202A triangle ruler, 1203 second triangle ruler button, 1204 protractor button, 1204A protractor, 1205A image, 120Y straight line, 130 memory, 140 memory interface, 141 storage medium, 150 communication interface, 200 stylus pen.

1.-10. (canceled)

11. An electronic apparatus comprising:
a touch panel; and
a processor for causing said touch panel to display an object including a plurality of types of regions,
said processor being configured to, based on a touch operation on said object being displayed on said touch panel, cause said object being displayed on said touch panel to be moved in accordance with a rule corresponding to the type of a region touched,
said object having at least one side as said region, and
said processor being configured to cause said object to be translated along said side based on the touch operation on said side.

12. The electronic apparatus according to claim 11, wherein:
said object has at least one vertex as said region; and
said processor is configured to cause said object to be rotated based on the touch operation on said vertex.

13. The electronic apparatus according to claim 12, wherein said processor is configured to cause said object to be rotated centering on the center of gravity of said object based on the touch operation on said vertex.

14. The electronic apparatus according to claim 12, wherein:
said object has an opposite side of said vertex; and
said processor is configured to cause said object to be rotated centering on the center of said opposite side based on the touch operation on said vertex.

15. The electronic apparatus according to claim 11, wherein:
said object has a plurality of vertices as said region; and
said processor is configured to, based on the touch operation on one of said plurality of vertices, cause said object to be rotated centering on any vertex adjacent to the one of said plurality of vertices.

16. The electronic apparatus according to claim 11, wherein said processor is configured to cause said object to be translated based on the touch operation on the inside of said object.

17. An electronic apparatus, comprising:
a touch panel; and
a processor for causing said touch panel to display an object including a plurality of types of regions,
said processor being configured to, based on a touch operation on said object being displayed on said touch panel, cause said object being displayed on said touch panel to be moved in accordance with a rule corresponding to the type of a region touched,
said object having at least one arc as said region, and
said processor being configured to cause said object to be rotated centering on the center of said arc based on the touch operation on said arc.

18. The electronic apparatus according to claim 17, wherein:
said object has at least one vertex as said region; and
said processor is configured to cause said object to be rotated based on the touch operation on said vertex.

19. The electronic apparatus according to claim 18, wherein said processor is configured to cause said object to be rotated centering on the center of gravity of said object based on the touch operation on said vertex.

20. The electronic apparatus according to claim 18, wherein:
said object has an opposite side of said vertex; and
said processor is configured to cause said object to be rotated centering on the center of said opposite side based on the touch operation on said vertex.

21. The electronic apparatus according to claim 17, wherein:
said object has a plurality of vertices as said region; and
said processor is configured to, based on the touch operation on one of said plurality of vertices, cause said object to be rotated centering on any vertex adjacent to the one of said plurality of vertices.

22. The electronic apparatus according to claim 17, wherein said processor is configured to cause said object to be translated based on the touch operation on the inside of said object.

23. A display method in an electronic apparatus including a touch panel and a processor, comprising:
causing, by said processor, said touch panel to display an object including a plurality of types of regions;
receiving, by said processor, a touch operation on said object being displayed on said touch panel; and
based on said touch operation, causing, by said processor, said object being displayed on said touch panel to be moved in accordance with a rule corresponding to the type of a region touched,
said object having at least one side as said region, and
said display method further comprising:
translating said object along said side based on the touch operation on said side.

24. The method according to claim 23, wherein:
said object has at least one vertex as said region; and
said method further comprises: rotating said object based on the touch operation on said vertex.

25. The method according to claim 24, further comprising:
rotating said object centering on the center of gravity of said object based on the touch operation on said vertex.

26. The method according to claim 24, wherein:
said object has an opposite side of said vertex; and
said method further comprising rotating said object centering on the center of said opposite side based on the touch operation on said vertex.

27. The method according to claim 23, wherein:
said object has a plurality of vertices as said region; and
said method further comprising:
rotating said object, based on the touch operation on one of said plurality of vertices, centering on any vertex adjacent to the one of said plurality of vertices.

28. The method according to claim 23, further comprising:
translating said object based on the touch operation on the inside of said object.
